(19) United States
(12) Patent Application Publication
(10) Pub. No.: US 2008/0104042 A1
(43) Pub. Date: May 1, 2008

(54) Personalized Search Using Macros

(75) Inventors: Zachary Gutt, Seattle, WA (US); Randy Kern, Seattle, WA (US); Laura Kern, Seattle, WA (US); Ramez Naam, Seattle, WA (US); Raghavendra Prabhu, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/552,643

(22) Filed: Oct. 25, 2006

(51) Int. Cl. G06F 17/30

(52) U.S. Cl. 707/4

(57) ABSTRACT

A system, a method and computer-readable media for personalizing a user search. Information is maintained that indicates a set of content selected by a user. A search macro is generated by utilizing this information. A user input defining a search query is received, and the search macro is utilized to further define the search query.

### BACKGROUND

The Internet allows access to vast amounts of information distributed over a multitude of computers. Although large amounts of information may be available on the Internet, finding desired content may not be easy or fast. To facilitate a user in locating content of interest, search engines have been developed. A conventional Internet search engine includes a crawler (also called a spider or bot) that visits an electronic document on a network, “reads” it, and then follows links to other electronic documents within a Web site. The crawler returns to the Web site on a regular basis to look for changes. An index, which is another part of the search engine, stores information regarding the electronic documents that the crawler finds. In response to one or more user-specified search terms, the search engine returns a list of network locations (e.g., uniform resource locators (URLs)) and metadata that the search engine has determined include electronic documents relating to the user-specified search terms. Some search engines provide categories of information (e.g., news, web, images, etc.) and categories within these categories for selection by the user, who can thus focus on an area of interest.

Search engine software generally ranks the electronic documents that fulfill a submitted search request in accordance with their calculated relevance and provides a means for displaying search results to the user according to their rank. A typical relevance ranking is a relative estimate of the likelihood that an electronic document at a given network location is related to the user-specified search terms in comparison to other electronic documents. For example, a conventional search engine may provide a relevance ranking based on the number of times a particular search term appears in an electronic document, or based on its placement in the electronic document (e.g., a term appearing in the title is often deemed more important than the term appearing at the end of the electronic document), etc. Link analysis, anchortext analysis, web page structure analysis, the use of a key term listing, and the URL text are other known techniques for ranking web pages and other hyperlinked documents.

There are many search engines on the Web, and most of these engines provide search results by performing a keyword search. In general, a keyword search will find the Web sites that have information related to the keywords and phrases specified in a search query. A search engine Web site may have a box for users to enter keywords and a button to press to start the search.

Rather than considering factors that might offer insight into a user's intended results, modern searching processes are designed to consider only explicit commands within a search query. Stated another way, search engines operate the same for all users regardless of different user needs and circumstances. Thus, if two users enter the same search query, they receive the same results, regardless of the users' individual interests and preferences.

To receive more personalized search results, the user may utilize advanced query syntax in the formatting of a query. For example, the user may define a query specifying the user's favorites Web sites. Using such a query, the search results may be limited to only relevant items from the specified Web sites. The portion of this query defining the Web sites may be stored as a search macro for further use. A search macro may include rules or query language that further defines/modifies a user's search input. Use of such an advanced querying technique, however, can be time consuming and may be beyond the capabilities of the casual Internet search engine user.

### SUMMARY

The present invention provides systems and methods for personalizing a user's search. Information is maintained that indicates a set of content selected by a user. For example, this selected content may include Web pages, social contacts and/or content feeds. A search macro is generated by utilizing this information. A user input defining a search query is received, and the search macro is utilized to further define the search query. For example, by utilizing the search macro to define the search query, the search results may include only items associated with the user-selected content.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWING

The present invention is described in detail below with reference to the attached drawing figures, wherein:

FIG. 1 is a block diagram of an exemplary network environment suitable for use in implementing embodiments of the present invention;

FIG. 2 illustrates a method in accordance with one embodiment of the present invention for personalizing a user's search;

FIG. 3 is a block diagram illustrating a system for providing personalized searching in accordance with one embodiment of the present invention;

FIG. 4 illustrates a method in accordance with one embodiment of the present invention for generating and utilizing search macros; and

FIG. 5 illustrates a method in accordance with one embodiment of the present invention for maintaining up-to-date search macros.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

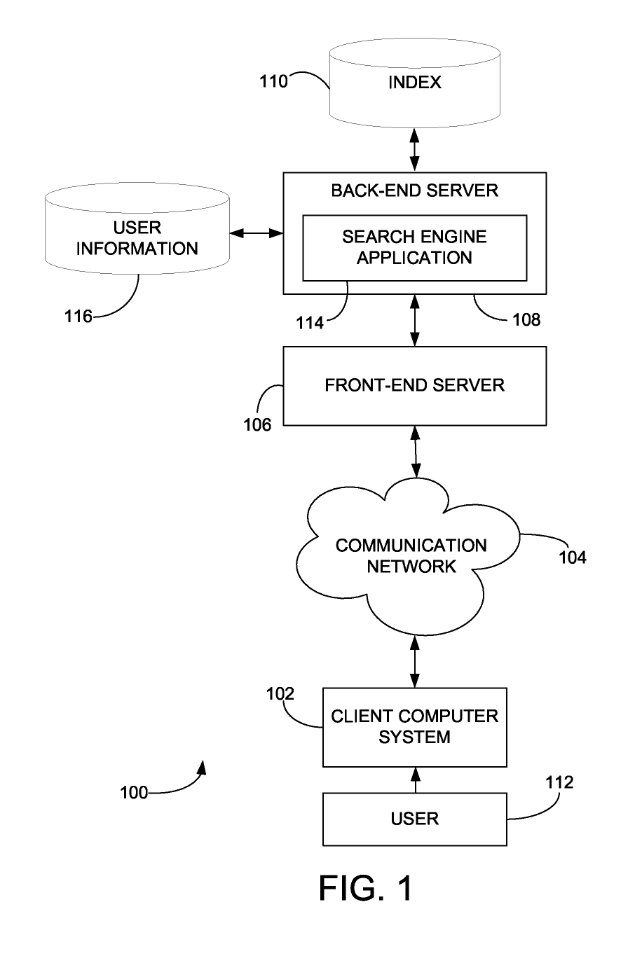

Referring initially to FIG. 1 in particular, an exemplary network environment for implementing the present invention is shown and designated generally as network environment 100. Network environment 100 is but one example of a suitable environment and is not intended to suggest any limitation as to the scope of use or functionality of the invention. Neither should the network environment 100 be interpreted as having any dependency or requirement relating to any one or combination of elements illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, specialty computing devices, servers, etc. The invention may also be practiced in distributed computing environments where tasks are performed by remote-processing devices that are linked through a communications network.

Referring now to FIG. 1, a client computer system 102 is coupled to a communication network 104, such as the Internet (or the World Wide Web). One or more servers communicate with the client computer system 102 via the network 104 using a protocol such as Hypertext Transfer Protocol (HTTP), a protocol commonly used on the Internet to exchange information. In the illustrated embodiment, a front-end server 106 and a back-end server 108 (e.g., web server or network server) are coupled to the network 104. The client computer system 102 employs the network 104, the front-end server 106 and the back-end server 108 to access Web page data stored, for example, in a central data index (index) 110.

Embodiments of the invention provide searching for relevant data by permitting search results to be displayed to a user 112 in response to a user-specified search request (e.g., a search query). In one embodiment, the user 112 uses the client computer system 102 to input a search request including one or more terms concerning a particular topic of interest for which the user 112 would like to identify relevant electronic documents (e.g., Web pages). For example, the front-end server 106 may be responsive to the client computer system 102 for authenticating the user 112 and redirecting the request from the user 112 to the back-end server 108.

The back-end server 108 may process a submitted query using the index 110. In this manner, the back-end server 108 may retrieve data for electronic documents (i.e., search results) that may be relevant to the user. The index 110 contains information regarding electronic documents such as Web pages available via the Internet. Further, the index 110 may include a variety of other data associated with the electronic documents such as location (e.g., links, or URLs), metatags, text, and document category. In the example of FIG. 1, the network is described in the context of dispersing search results and displaying the dispersed search results to the user 112 via the client computer system 102. Notably, although the front-end server 106 and the back-end server 108 are described as different components, it is to be understood that a single server could perform the functions of both.

A search engine application (application) 114 is executed by the back-end server 108 to identify web pages and the like (i.e., electronic documents) in response to the search request received from the client computer system 102. More specifically, the application 114 identifies relevant documents from the index 110 that correspond to the one or more terms included in the search request and selects the most relevant web pages to be displayed to the user 112 via the client computer system 102.

The environment 100 also includes a user information data store 116. In one embodiment, a profile and other information associated with the user 112 may be stored in the user information data store 116. For example, this information may include favorite Web sites, contacts, favorite blog sites and/or subscribed-to content feeds. When the user 112 logs into a Web portal site, the user information in the data store 116 may be used to present personalized content to the user. Further, as will be discussed, the user information in the data store 116 may be leveraged to provide more personalized searching.

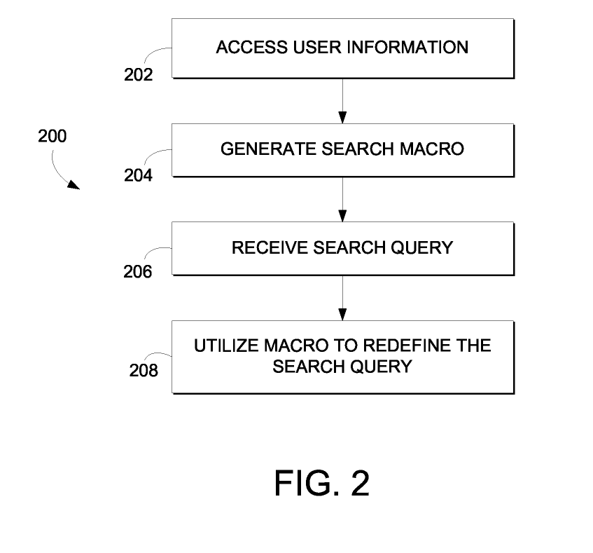

FIG. 2 illustrates a method 200 for personalizing a user's search. At 202, information indicating content selected by the user is accessed. In one embodiment, the method 200 may be performed with respect to a user's account associated with a content portal. Such content portals generally allow users to define content of interest. For example, the user may define a set of links indicating the user's favorite Web sites. Also, the user may subscribe to content feeds and blog sites. As another example, the user may define a set of other users on the Internet (i.e., a contacts list). As will be apparent to those skilled in the art, the user may select a wide variety of content to be associated with their user account. Further, the present invention is not limited to embodiments that utilize Web-based content, and information indicating user-selected content may be stored in a variety of different platforms and for a variety of different reasons.

A search macro is generated at 204 by utilizing at least a portion of the information indicating content selected by the user. As previously mentioned, a search macro may include rules or query syntax that further defines/modifies a user's search input to yield different search results. For example, a search macro may provide additional query language to be combined with a user's search query so as to provide more personalized/relevant search results. A search macro may include advanced query syntax that may be difficult or time consuming for a user to enter. So the search macro may allow a user to efficiently target their searching without spending a large amount of time entering a long or complicated search query.

To generate the search macro, the user-selected content may be utilized in a variety of different ways. In one embodiment, the user may have defined their favorite Web sites. In this embodiment, the user may desire to perform certain searches across only their favorite sites, and a macro may be generated for this purpose. Such a macro, when implemented, may augment a search query with operators that limit the search to only the user's favorite sites. Accordingly, this “my favorite Web site” macro may allow for personalized searching of a user's favorite sites.

As another example, a “my social network” macro may be created by utilizing contacts associated with the user. This macro may provide a convenient way for users to limit a search to their own social network. For instance, the user may desire to search Web sites (e.g., blogs) associated with their friends. Similarly, a “my favorite blogs” macro or a “my favorite feeds” macro may be used to search across a set of blogs/feeds the user is subscribed to. In view of these examples and as will be appreciated by those skilled in the art, depending on the type of information accessed at 202, the method 200 may leverage such information in a variety of different manners to generate search macros for personalized searching.

At 206, a search input is received from a user. In one embodiment, the search input is a set of key words indicating desired content. As previously mentioned, the method 200 may be performed in conjunction with any number of searching platforms. For example, there are numerous Internet search engines in existence today, while other search utilities exist to search hard drives and databases.

The user may select to use the search macro along with the submitted query. For example, the user may select to use the “favorite Web site” macro to limit search results to results from their favorite sites. In one embodiment, selection of such a macro is made by selecting a visual element presented on a search interface.

Upon receiving the search query and the request to use a search macro, the search query is redefined at 208. For example, the search macro may include additional query text (including text formatted in accordance with advanced query syntax). A query parser may receive the macro's query text for processing along with the user-entered search terms. The query, as defined by the user input and the macro, may then be parsed and used to locate search results. Accordingly, the search query is defined, in part, by the search macro, and, thus, the search results will reflect the content defined by the macro.

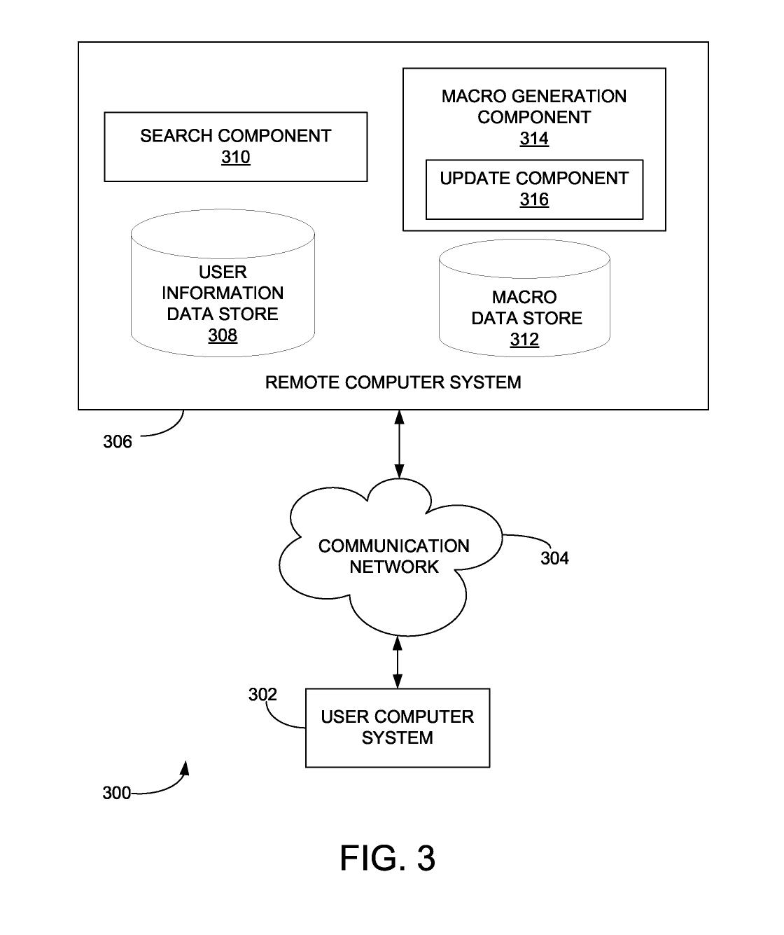

FIG. 3 illustrates a system 300 for providing personalized searching. The system 300 includes a user computer system 302, which is in communication with a communication network 304. The network 304 may include any number of public and/or private networks, while the communications between the user computer system 302 and the network 304 may utilize a wired and/or wireless connection. The user computer system 302 may be one of any number of computer systems capable of communicating with the network 304. For example, the user computer system 302 may be a desktop or laptop computer. The user computer system 302 may also be a mobile device and/or a handheld device (e.g., a mobile telephone or a personal digital assistant). In one embodiment, the user computer system 302 provides an Internet browser application that allows the user to view content and Web sites available via the Internet.

The system 300 also includes a remote computer system 306. While FIG. 3 presents the remote computer system 306 as a single entity, it should be noted that the remote computer system 306 may include a variety of computing devices. As such, the remote computer system 306 may be a distributed set of computing devices instead of the single element present on FIG. 3. In one embodiment, the remote computer system 306 may provide a Web site such as a content portal.

The remote computer system 306 includes a user information data store 308, which stores information indicating content selected by a user. For instance, the data store 302 may store content associated with user accounts. Such content may be stored in a variety of different platforms and for a variety of different reasons. For example, a user may define their favorite Web pages, blogs, content feeds and social contacts. These selections may be stored in the user information data store 308. Additionally, content indicating a user's search history, browsing history and other activities may be stored in the data store 308. Indeed, a wide variety of content related to the user may be stored by the system 306 in the data store 308.

A search component 310 is also included in the remote computer system 306. The search component may provide a variety of functions allowing searching of the Internet or other media. In one embodiment, the search component 310 is associated with an Internet search engine. In this embodiment, a user of the computer system 302 may submit key words as a query over the communication network 304 for processing by the search component 310. Responsive to this user query, the search component 310 may return search results indicating Web pages identified as relevant to the submitted key words.

The remote computer system 306 also includes a macro data store 312. The macro data store 312 may store search macros associated with users to the system 300. Search macros have been previously discussed, and a variety of such macros may be stored in the data store 312. When a user requests use of a macro, the requested macro may be submitted to the search component 310 for processing along with a user-defined search query.

To generate the macros, the computer system 306 includes a macro generation component 314. The macro generation component 314 may be configured to generate macros by accessing information stored in the user information data store 308. In one embodiment, a user may be presented the option for a macro to be automatically created by the macro generation component 314. For example, the macro may limit search results to hits found on Web sites defined in the data store 308 as the user's favorite sites. Upon receiving user selection for such a macro to be created, the macro generation component 314 may access the favorite Web site information in the data store 308 and generate the macro. The macro generation component 314 may generate query text to be parsed by the search component 310 when the macro is utilized. After the macro generation component 314 completes the macro, the macro is stored in the macro data store 312. In one embodiment, the user is presented a listing of his or her saved macros for selection when entering a search request.

Over time, the information in the user information data store 308 may change. For instance, a user may add and/or remove Web sites from their “favorites.” Such changes in the user information data store 308 may dictate that associated macros be updated so as to reflect the current state of the user information. Returning to the “my favorite Web site” macro example, the user may frequently change which sites are stored as favorites and may desire for the “my favorite Web site” macro to remain current. To update the macros, the macro generation component 314 includes an update component 316. This update component 316 may keep the various macros up-to-date in a variety of different ways. In one embodiment, each time a macro is to be used with a search, the update component 316 may, in real time, access the user information data store 308 to ensure data consistency. In another embodiment, there may exist a linking between the information in the user information data store 308 and a macro. In this embodiment, the update component 316 may be notified when there is a change to information in the information data store 308. Responsive to such a notice, the update component 316 may update the linked macros to reflect the new user information.

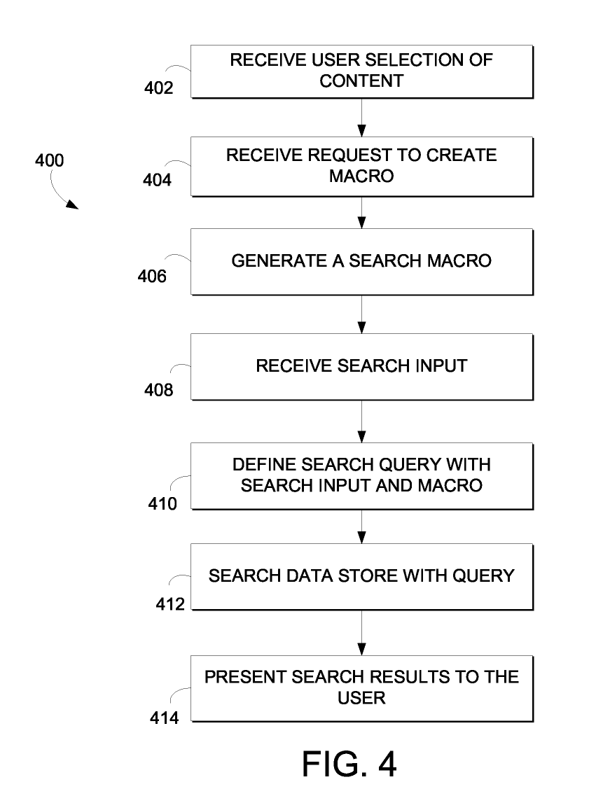

FIG. 4 illustrates a method 400 for generating and utilizing search macros. At 402, a content selection is received from the user. A wide variety of content may be selected by the user via any number of different interfaces. For example, the user may explicitly define a set of content. Alternately, the content selection may be implied from user actions. In one embodiment, the user is provided a Web-based interface in which content from various sources may be identified and selected.

At 404, a request to create a search macro is received. As previously mentioned, a search macro may include rules or query syntax that further defines/modifies a user's search input. For example, the user may request that the previously discussed “my favorite Web sites” macro be created. In one embodiment, the user may be presented an interface (e.g., via a Web page) in which various macro options are presented. For instance, the user may be presented the option to create a macro that limits the results of a search query to content associated with the selected items of content. In one embodiment, the user may authorize the creation of multiple macros at the same time (e.g., macros associated with different content sources).

At 406, a search macro is generated in response to the request received at 404. For example, the macros may be automatically created using content from a third party server or content from the client (e.g., from a browser history or an OPML file stored on the user's computer). In one embodiment, the macro may define text in accordance with search query syntax. In this case, creation of the macro may involve automatically generating such text.

At 408, a search input is received. For example, an Internet search engine may provide a user interface in which the user may enter search terms. Alternately, a search utility associated with a local or remote data store may provide such an interface. In addition to entering the search input, the user may indicate a desire for the search macro to be applied to the search query.

At 410, the search query is defined with both the search macro and the search input. In one embodiment, a search query parser utilizes both the search macro and the search input to define the search query. Using the search query, the data store is searched at 412. Subsequently, the results of the query execution may be presented to the user at 414. For example, if the “my favorite Web site” macro was utilized, the search results may only include hits from the Web sites selected by the user. In one embodiment, information from the macro may be used to automatically reorder/change the search results without the user having to explicitly select a macro.

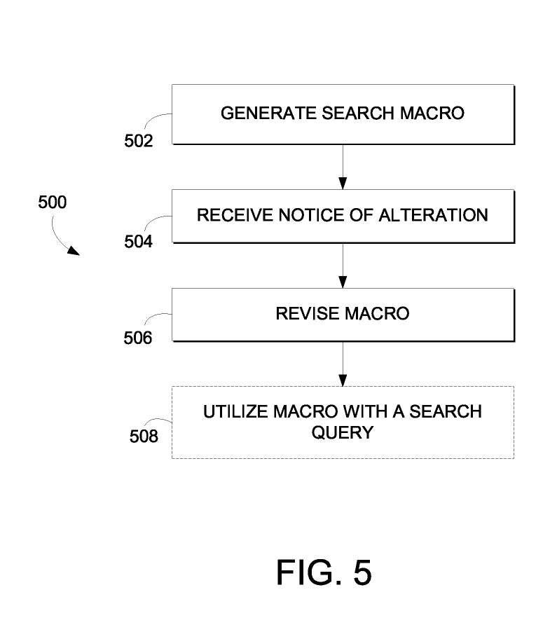

FIG. 5 illustrates a method 500 for maintaining up-to-date search macros. At 502, a search macro is generated. In one embodiment, the search macro may be associated with a set of content selected by a user. Information defining the selected content may be accessed to generate the macro. Such information may also record the existence of the search macro. Over time, the information used to generate the search macro may change. For example, if the search macro is associated with a set of Web sites selected by the user, the user may add or remove such sites from the set.

At 502, notice is received concerning alteration to the information used to generate the search macro. For example, when the user alters the selected content, linking information stored along with this content may dictate that notice be provided in response to such an alteration.

At 506, the search macro is revised in response to the alteration. For example, the user may add an additional item of content to their set of selected content. Accordingly, the search macro will be revised so as to reflect this change in the selected content. Subsequently, at 508, the search macro is utilized with a search query. As will be appreciated by those skilled in the art, the method 500 allows the search macro to remain up-to-date despite changes to the user-selected content.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. One or more computer-readable media having computer-useable instructions embodied thereon to perform a method for personalizing a user search, said method comprising:
accessing information indicating a set of content selected by a user;
generating a search macro by utilizing at least a portion of said information;
receiving a user input defining a search query;
utilizing said search macro to further define said search query.

2. The media of claim 1, wherein said method further comprises searching a data store by utilizing said search query defined by said user input and said search macro.

3. The media of claim 2, wherein said searching is performed by an Internet search engine.

4. The media of claim 1, wherein said set of content includes one or more Web pages selected by said user.

5. The media of claim 1, wherein said macro includes text formatted in accordance with a query syntax.

6. The media of claim 1, wherein said method further comprises receiving an input requesting said search macro be generated.

7. The media of claim 6, wherein said generating is performed in response to said input without further required user intervention.

8. The media of claim 1, wherein said method further comprises updating said search macro in response to one or more changes to said information.

9. A system for locating and providing search results to a user, said system comprising:
a user information data store that stores information indicating a set of content selected by a user;
a macro data store that stores one or more macros associated with said user;
a macro generation component configured to generate said one or more macros by accessing said information in said user information data store and by identifying one or more information sources associated with at least a portion of a set of content; and
a search component configured to utilize a search query input and at least one of said one or more macros to locate search results responsive to said search query input.

10. The system of claim 9, wherein said macro generation component is further configured to generate text formatted in accordance with a query syntax for each of at least a portion of said one or more macros.

11. The system of claim 9, wherein said macro generation component comprises a macro update component configured to update at least a portion of said one or more macros in response to an alteration to at least a portion of said information.

12. The system of claim 9, wherein said search component is configured to define a search query by utilizing said search query input and at least one of said one or more macros.

13. The system of claim 9, wherein said search component includes an Internet search engine.

14. The system of claim 9, wherein said set of content includes one or more items from a list including: a Web page; a personal contact of said user; a blog site; and a content feed.

15. One or more computer-readable media having computer-useable instructions embodied thereon to perform a method for providing personalize searching, said method comprising:
generating a search macro by accessing information indicating a set of content selected by a user, wherein said search macro includes query text associated with said macro;
receiving notification of an alteration to said set of content; and
revising said macro in response to the alteration of said set of content.

16. The media of claim 15, wherein said revising includes updating said query text associated with said macro.

17. The media of claim 16, wherein said updating is performed without user input.

18. The media of claim 15, wherein said method further comprises receiving a user request to perform a search using said macro.

19. The media of claim 18, wherein said method further comprises using the macro to define a search query in response to said user request.

20. The media of claim 15, wherein said macro identifies one or more information sources associated with said set of content.
